(19) United States
(12) Patent Application Publication
(10) Pub. No.: US 2008/0175687 A1
(43) Pub. Date: Jul. 24, 2008

(54) Double-ended mounting stud and tool

(76) Inventors: Hans Christian Lassen, Roland, IA (US); Uwe Lassen, Roland, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/244,527

(22) Filed: Oct. 6, 2005

(51) Int. Cl. F16B 35/04; B25B 23/00

(52) U.S. Cl. 411/389; 81/177.85

(57) ABSTRACT

A double-ended stud and attachment tool is provided, comprising a double-ended stud having a shank adapted for attachment to a mounting surface, a threaded end adopted for receipt of a securement device, and a collar located therebetween; and an attachment tool with a first end for releasable securement to the threaded end of said stud, a second end adapted for securement to a tool.

### BACKGROUND OF THE INVENTION

1. Field of the Invention

The present invention relates to a double-ended mounting stud and tool. In particular, to a double-ended stud and attachment tool comprising a double-ended stud having a shank adapted for attachment to a mounting surface, a threaded end adopted for receipt of a securement device, and a collar located therebetween; and an attachment tool with a first end for releasable securement to the threaded end of said stud, a second end adapted for securement to a tool.

2. Background.

Double-ended fasteners such as mounting studs are well known in the art. They are used as a connecting means in a wide variety of applications, including to allow for fastening articles to cement walls, to wood surfaces, to plastic surfaces, and the like. The normal function of mounting studs is to provide the ability to fasten something to a surface that otherwise is not easily adapted for use of a traditional bolt, screw, or nail. This may be the case because the surface is too thick to allow for drilling a hole through the entire thickness of the surface, or for aesthetic purpose a hole with a bolt end protruding therefrom is not desirable or possible.

Typically mounting studs are comprised of a first end or shank, sometimes threadable, which mounts to a generally planer surface of some type. A second end extends co-axially away from the first end and normally comprises threads. The second end is adapted for receipt of a nut or other threaded locking device. A collar separates the two ends and serves to limit the threading movement of one or both threaded ends, and to strengthen securing device integrity. In this manner articles can be attached to the planer surface by threaded connection.

One particular application that utilizes double-ended studs is in the mounting of lights to vehicle surfaces and/or trailers. For example, brake lights for trailers are often made with a hard resilient plastic backing/casing. The light is bolted to the trailer. This requires the use of a double-ended mounting stud because it is difficult and costly to fabricate a light with a stud protruding as this articles are normally molded, and the electronics and aesthetic of the lens prevent drilling a hole through the thickness of the article.

Prior art mounting studs often have a ribbed shank that is designed for receipt within a mounting hole or slot located in the back of the light. The shank is slightly oversized and fits snugly into the hole such that the ribs will hold the stud in place after pressing it into place, however, it is very difficult and sometimes destructive to finished products to press bolds in this way. A collar limits the movement of the shank. A threaded co-axial end protrudes from the back of the light and can receive a bolt or nut that ultimately secures the light to the trailer.

Once installed the stud generally produces satisfactory results, however, the process of installation is difficult. It takes a great deal of force to insert the shank into the light, or article to be mounted, and generally this has to be done manually. There is no effective generally purpose of specific tool for this purpose. Also, use of ribs requires an oversized shank, which increases the force required to insert the stud, and the ribs are not the most effective gripping means. Additionally, the force required can sometime crack or damage the surface of the article that the shank is inserted into.

Accordingly, there is a need for an improved double-ended mounting stud that substantially eliminates the problems of prior art devices.

### SUMMARY OF THE INVENTION

An object of the present invention is to provide an improved double-ended mounting stud.

These and other objects of the present invention will become apparent to those skilled in the art upon reference to the following specification, drawings, and claims.

The present invention intends to overcome the difficulties encountered heretofore. To that end, a double-ended stud and attachment tool is provided, comprising a double-ended stud having a shank adapted for attachment to a mounting surface, a threaded end adopted for receipt of a securement device, and a collar located therebetween; and an attachment tool with a first end for releasable securement to the threaded end of said stud, a second end adapted for securement to a tool.

### BRIEF DESCRIPTION OF THE DRAWINGS

FIG. 1 is a back view of a lighting product and a side view of a prior art double-ended mounting stud.

FIG. 2 is a side view of a double-ended mounting stud and attachment tool.

FIG. 3 is a side view of the stud secured to the tool.

### DETAILED DESCRIPTION OF THE INVENTION

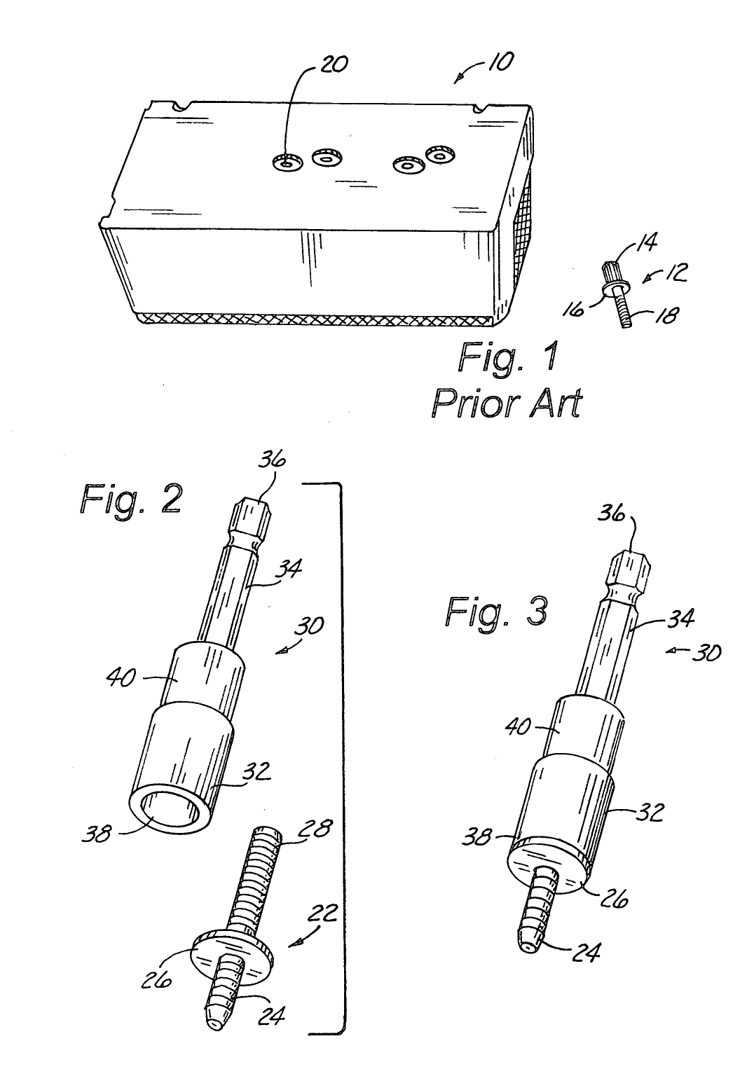

In the Figures, a prior art double-ended mounting stud and a double-ended mounting stud and attachment tool of the present invention are shown. In particular, FIG. 1 shows a backside of a lighting product 10 and a prior art double-ended mounting stud 12. The double-ended mounting stud 12 is comprised of a ribbed shank 14, a collar 16, and threaded end 18. The configuration and operation is as described hereinabove. The shank 14 of the stud 12 inserts into one of a number of holes 20 located in the back of the lighting product 10. Thereby enabling mounting the lighting product 10 to some structure by securing a nut/bolt to the threaded end 18 of the stud 12.

Those of ordinary skill in the art will understand that foregoing example is illustrative and that the invention is not limited thereto. The present invention is applicable to any application that utilizes a double-ended mounting stud.

FIG. 2 shows a double-ended mounting stud 22 of the present invention comprised of a threaded mounting shank 24, a collar 26, and a threaded end 28. Also shown is an attachment tool 30. The tool 30 has a first end 32 designed for threaded engagement with the threaded end 28 of the stud 22, and a second co-axial end 34 opposite thereto. The second end 34 has a six-sided head 36 adapted for securing to a ratchet tool (not shown), such as a drill, for driving the threaded mounting shank 24 into one of the holes 20 of the lighting product 10.

In this manner, the first end 32 of the tool 30 is hollow to fit over the threaded end 28 of the stud 22. The first end 32 of the tool 30 includes a wide non-threaded section 38 and tapered threaded section 40 such that only the top threads of the threaded end 28 of the stud 22 furthest from the collar 26 engage with the threads located inside of the tapered portion 40 of the interior of the first end 32 of the tool 30. Preferably, the tool 30 threads onto the stud 22 with two or three rotations of the tool 30 (see FIG. 3). The reduced number of threads used to secure the tool 30 to the stud 22 also ensures that the tool 30 can be easily removed from the stud 22 after the stud is threaded into place. The tension of the threads holding the tool 30 and stud 22 is much less than the thread tension holding the stud 22 into the hole 20. In this, manner the tool 30 can be quickly attached and removed from the stud 22.

In operation the stud 22 is threaded onto the tool 30 and then the threaded shank 24 of the stud 22 is inserted into one of the holes 20. The ratchet tool can be attached to the head 36 of the tool 30 for rapid insertion of the stud 22, and removal of the tool 30. Additionally, the use of threads on the shank 24 allows for a better grip and fit of the stud 22 within the holes 20. After insertion, the ratchet tool is reversed and the tool 30 is removed and can be reused.

The problems of the prior art are substantially eliminated through the combined use of the stud 22 and tool 30. The combination allows for easy insertion of the stud 22. The use of limited threaded engagement of the threaded end 28 of the stud 22 and the first end 32 of the tool 30 allows for easy removal and attachment of the tool 30. Furthermore, the threaded shank 24 of the stud 22 provides a better grip without the application of the forces that might damage the article into which the stud 22 is being inserted.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A double-ended stud and attachment tool, comprising:
a double-ended stud having a shank adapted for attachment to a mounting surface, a threaded end adopted for receipt of a securement device, and a collar located therebetween; and
an attachment tool with a first end for releasable securement to said threaded end of said stud, a second end adapted for securement to a tool.

2. The invention in accordance with claim 1 wherein said shank end of said double-ended stud is threaded.

3. The invention in accordance with claim 1 wherein said second end of said attachment tool has a ratchet head adapted for receipt of a ratchet tool.

4. The invention in accordance with claim 1 wherein said first end of said tool comprises a wide section and tapered section such that only a portion of said threads of said threaded end of said stud engage said tapered section of said tool.
